(19) United States
(12) Patent Application Publication
(10) Pub. No.: US 2010/0095848 A1
(43) Pub. Date: Apr. 22, 2010

(54) AIR PURIFIER AND AIR CONDITIONER HAVING THE SAME

(76) Inventors: Chin-Hyuk Chang, Gyoungsangnam-do (KR); Sung-Hwa Lee, Gyoungsangnam-do (KR); Tae-Byoung Park, Gyoungsangnam-do (KR); Jae-Youn Park, Gyoungsangnam-do (KR)

Correspondence Address: MCKENNA LONG & ALDRIDGE LLP, 1900 K STREET, NW, WASHINGTON, DC, 20006, US

(21) Appl. No.: 12/312,637

(22) PCT Filed: Mar. 18, 2008
(86) PCT No.: PCT/KR2008/001517

§ 371 Date: May 20, 2009

(30) Foreign Application Priority Data
Jul. 5, 2007 (KR) 10-2007-0067726

(51) Int. Cl. B03C 3/08

(52) U.S. Cl. 96/82

(57) ABSTRACT

Provided are an air purifier and an air conditioner including the same. The air purifier includes a ground electrode part, a discharge electrode, at least a pair of magnetic force generators, and a voltage generator. The ground electrode part has at least a pair of flat plates. The discharge electrode is located between the flat plates and separated from the flat plates. The at least a pair of magnetic force generators is provided to the flat plates, respectively, to generate a magnetic field and allow attractive force to be applied between the flat plates. The voltage generator applies a voltage between the ground electrode part and the discharge electrode.

### TECHNICAL FIELD

The present disclosure relates to an air purifier and an air conditioner having the same.

### BACKGROUND ART

Generally, an air conditioner is an apparatus cooling/heating an indoor space using a compressor, a condenser, an expander, and an evaporator.

The air conditioner includes an indoor unit installed inside the indoor space and an outdoor unit installed outside an outdoor space. The indoor unit and the outdoor unit can be integrally formed depending on the kind of the air conditioner.

The indoor unit includes a blower fan ventilating air, and an indoor heat exchanger allowing heat exchange to be performed between air and refrigerant inside the indoor unit. Also, the indoor unit can include an air purifier purifying introduced air.

### DISCLOSURE OF INVENTION

### Technical Problem

Embodiments provide an air purifier that increases air purifying efficiency, and an air conditioner having the same.

Embodiments also provide an air purifier where a magnetic field and an electric field are formed in the same space, and an air conditioner having the same.

### Technical Solution

In one embodiment, an air purifier includes: a ground electrode part having at least a pair of flat plates; a discharge electrode between the flat plates, separated from the flat plates; at least a pair of magnetic force generators provided to flat plates, respectively, to generate a magnetic field and allow attractive force to be applied between the flat plates; and a voltage generator applying a voltage between the grand electrode part and the discharge electrode.

In another embodiment, an air conditioner includes: a main body in which an air intake hole and an air discharge hole are formed; a heat exchanger provided to the main body to allow air suctioned through the air intake hole to exchange heat; and an air purifier purifying air suctioned to the main body, the air purifier including: a ground electrode part having a pair of flat plates, the grand electrode being an anode; a discharge electrode between the flat plates, the discharge electrode being a cathode; at least a pair of magnetic force generators provided to flat plates, respectively, to generate a magnetic field and allow attractive force to be applied between the flat plates; and a voltage generator applying a voltage between the ground electrode part and the discharge electrode.

The details of one or more embodiments are set forth in the accompanying drawings and the description below. Other features will be apparent from the description and drawings, and from the claims.

### Advantageous Effects

According to a proposed embodiment, since a strong magnetic field is formed inside a space where an electric field is formed, air purifying efficiency improves.

That is, since an N pole or an S pole of a first magnetic force generator faces an S pole or an N pole of a second magnetic force generator, strong attractive force is applied between the magnetic force generators, so that an electron performs a cyclotron motion, the collision frequency between an electron and foreign substances contained in air increases, and air purifying efficiency improves.

Also, since the magnetic force generator is mounted on the flat plate, airflow can be smooth.

### BRIEF DESCRIPTION OF THE DRAWINGS

FIG. 1 is a cross-sectional view of an air conditioner having an air purifier according to an embodiment.

FIG. 2 is a schematic perspective view of the construction of an air purifier according to an embodiment.

FIG. 3 is a plan view of the air purifier according to the embodiment.

FIGS. 4 and 5 are views illustrating an electron movement path in the air purifier according to the embodiment.

FIG. 6 is a front view of an air purifier according to another embodiment.

FIGS. 7 and 10 are views illustrating an air purifier according to other embodiments.

FIG. 11 is a graph illustrating dust collecting efficiency of the air purifier according to the embodiment.

FIGS. 12 to 15 are graphs illustrating dust collecting efficiency of the air purifier according to other embodiments.

FIG. 16 is a view illustrating the construction of an air purifier according to still another embodiment.

### MODE FOR THE INVENTION

Reference will now be made in detail to the embodiments of the present disclosure, examples of which are illustrated in the accompanying drawings.

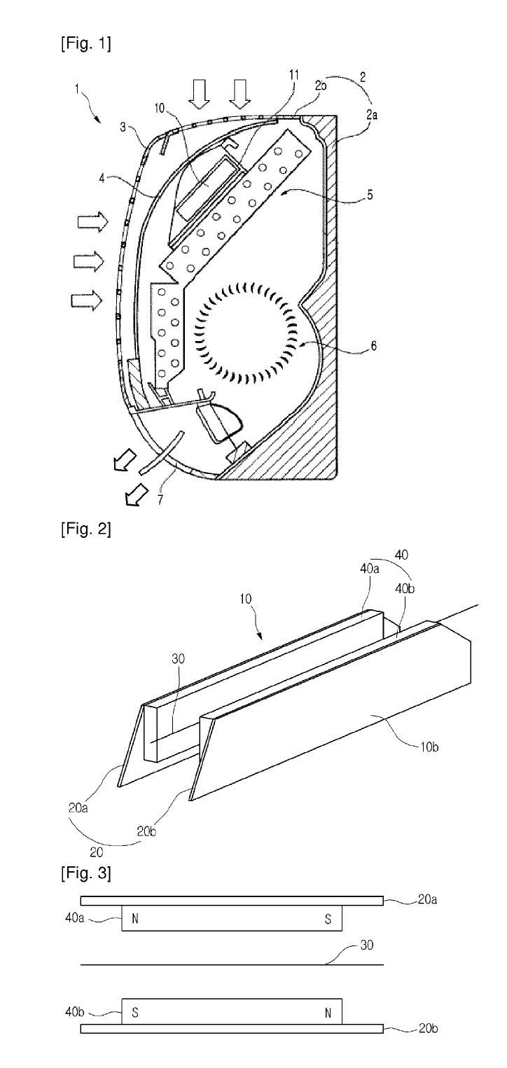

FIG. 1 is a cross-sectional view of an air conditioner having an air purifier according to an embodiment.

Referring to FIG. 1, the air conditioner 1 includes a main body 2 forming an appearance, a suction grill 3 rotatably coupled to the main body 2, a blower fan 6 allowing air to be suctioned to the inside of the main body 2 and allowing suctioned air to be discharged, a heat exchanger 5 allowing heat to be exchanged between air suctioned to the inside of the main body 2 and refrigerant inside the air conditioner 1, and an air purifier 10 purifying air suctioned to the inside of the main body 2.

In detail, the main body 2 includes a rear frame 2a installed on a wall surface of an indoor space, and a front frame 2b coupled to the front side of the rear frame 2a.

Also, an air discharge hole 7 discharging air is formed in the lower portion of the front frame 2b. The suction grill 3 defines an air intake hole.

The air purifier 10 is mounted in the heat exchanger 54 through a mounting case 82. A filter 4 filtering air being suctioned is installed in the rear side of the suction grill 3.

An operation of the air conditioner will be briefly described.

When the blower fan 6 rotates, air in an indoor space is suctioned to the inside of the main body 2 through the suction grill 3. The suctioned air is purified while it passes through the filter 4. While the air that has passed through the filter 4 passes through the air purifier 10, foreign substances contained in the air are ionized and removed due to a cyclotron motion. After that, the air changes into cool air or hot air while it passes through the heat exchanger 5, and then is discharged to the indoor space through the air discharge hole 7.

The air purifier will be described below in detail.

FIG. 2 is a schematic perspective view of the construction of an air purifier according to an embodiment.

Referring to FIG. 2, the air purifier 10 includes a ground electrode part 20, a discharge electrode 30, and a magnetic force generator 40. The ground electrode part 20 that is a cathode has flat plates 20a and 20b that are parallel to and separated from each other by a predetermined distance. The discharge electrode 30 that is an anode is separated by a predetermined distance between the flat plates 20a and 20b of the ground electrode part 20 to generate an electric field in a space between the flat plates 20a and 20b. The magnetic force generators 40 are mounted on the flat plates 20a and 20b of the ground electrode part 20, respectively, to generate a magnetic field in the space where the electric field has been generated.

A voltage generator applying a (+) voltage to the discharge electrode 30 and applying a (−) voltage to the ground electrode part 20 is omitted in FIG. 2. Since the voltage generator is well known to those skilled in the art, detailed description thereof is omitted.

In detail, a (−) voltage is applied to the ground electrode part 20, and a (+) voltage is applied to the discharge electrode 30, so that an electric field is generated between the ground electrode part 20 and the discharge electrode 30, that is, between the discharge electrode 30 and the flat plates 20a and 20b.

At this point, to widen the space where the electric field is generated and make airflow flowing to the air purifier 10 smooth, a line electrode may be used as the discharge electrode 30.

Also, the magnetic force generator 40 includes a first magnetic force generator 40a and a second magnetic force generator 40b.

The magnetic force generators 40a and 40b are mounted on the flat plates 20a and 20b so that more greater magnetic force can be applied to the space where the electric field is generated as illustrated in FIG. 2 to allow magnetic field lines between the magnetic force generators 40a and 40b to densely aggregate in the space where the electric field is generated.

To allow the intensity of the magnetic field to densely aggregate in the space where the electric field is generated, the first and second magnetic force generators 40a and 40b are mounted on the flat plates 20a and 20b. At this point, the first and second magnetic force generators 40a and 40b are mounted such that opposite poles thereof at least partially face each other.

The magnetic force generator 40 can be a permanent magnet, an electromagnet, or a conductive magnetic material. The magnetic force generator 40 may be formed in the form of a flat plate so that it can be easily mounted on the flat plates 20a and 20b.

Also, when the magnetic force generators 40a and 40b are mounted on the flat plates 20a and 20b, they can be attached on the flat plates 20a and 20b using an insulating material such as an adhesive, or can be fixed using a separate mounting member.

In the case where the magnetic force generator 40 is mounted on the ground electrode part 20 using the above-described method, workability is excellent and the magnetic force generators 40a and 40b are mounted on the flat plates 20a and 20b of the ground electrode part 20, so that airflow is not hindered.

When an electron of the discharge electrode 30 moves under the magnetic field generated by the magnetic force generator 40, a path up to the ground electrode part 20 is determined according to the intensity of the magnetic field.

For example, when there is no magnetic field, an electron reaches the ground electrode part 20 along an almost straight path, so that the collision frequency of the electron with air (or contaminated material) inside the air purifier is small. When the intensity of the magnetic field is small, an electron moves along a parabolic path. When the intensity of the magnetic field is large, an electron performs a cyclotron motion.

At this point, when the radius of the electron's cyclotron motion is smaller than a distance between the discharge electrode 30 and the ground electrode part 20, the electron comes back to the discharge electrode 30. Therefore, the intensity of the magnetic field needs to be set with consideration of this characteristic. Of course, the radius of the cyclotron motion also depends on temperature, the intensity of the magnetic field, the mass and charge of a contaminated material.

In the case where an electron moves along the parabolic path or the path of the cyclotron motion, the collision frequency of the electron with gas molecules and molecules of contaminants in air increases to generate a collision ionization operation over a wider region. That is, plasma can be generated over a wide region when a magnetic field is applied to the air purifier, efficiency of removing a harmful gas can be improved.

FIG. 3 is a plan view of the air purifier according to the embodiment.

Referring to FIG. 3, the magnetic force generators 40a and 40b are mounted on the flat plates 20a and 20b of the ground electrode part 20. The N and S poles of the magnetic force generators 40a and 40b are arranged in the lengthwise direction of the flat plates 20a and 20b of the ground electrode part 20. That is, the N pole of the first magnetic force generator 40a faces the S pole of the second magnetic force generator 40b, and the S pole of the first magnetic force generator 40a faces the N pole of the second magnetic force generator 40b to allow a strong magnetic force is formed between the flat plates 20a and 20b, which is the space where the electric field is generated.

According to the embodiment, both the electric field and the magnetic field are generated between the flat plates 20a and 20b. Particularly, regarding the magnetic field, a strong magnetic field can be generated in the space where the electric field is generated by polarity arrangement of the magnetic force generators 40a and 40b.

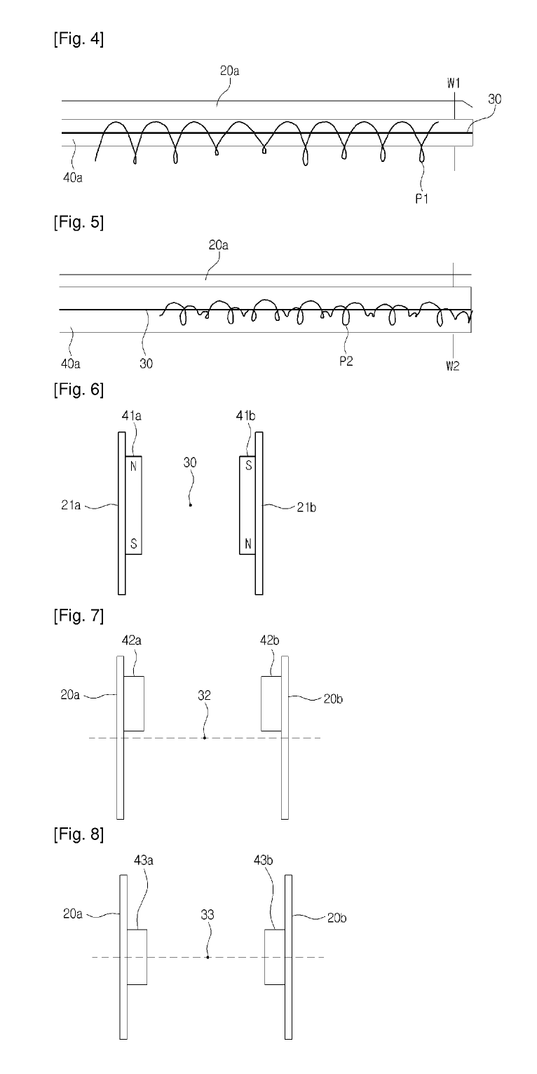

FIGS. 4 and 5 are views illustrating an electron movement path in the air purifier according to the embodiment.

Referring to FIGS. 4 and 5, an electron performs a cyclotron motion in a space where the electric field and the magnetic field have been generated. The motion of an electron on the first magnetic force generator 40a will be exemplarily described.

An electron performs a cyclotron motion having a radius inversely proportional to the width or height (size) of the first magnetic force generator 40a in the space where the electric field and the magnetic field have been generated.

That is, a radius along a path P1 in the width W1 of the first magnetic force generator 40a is greater than a radius along a path P2 in the width W2 of the first magnetic force generator 40a (W1<W2).

FIG. 6 is a front view of an air purifier according to another embodiment.

Referring to FIG. 6, magnetic force generators 41a and 41b are mounted on flat plates 21a and 21b of a ground electrode part 20, respectively. The poles N and S of the magnetic force generators 41a and 41b are arranged in the height direction of the flat plates 21a and 21b of the ground electrode part 20.

That is, the N pole formed on the upper portion of the first magnetic force generator 40a faces the S pole formed on the upper portion of the second magnetic force generator 40b, and the S pole formed on the lower portion of the first magnetic force generator 40a faces the N pole formed on the lower portion of the second magnetic force generator 41b.

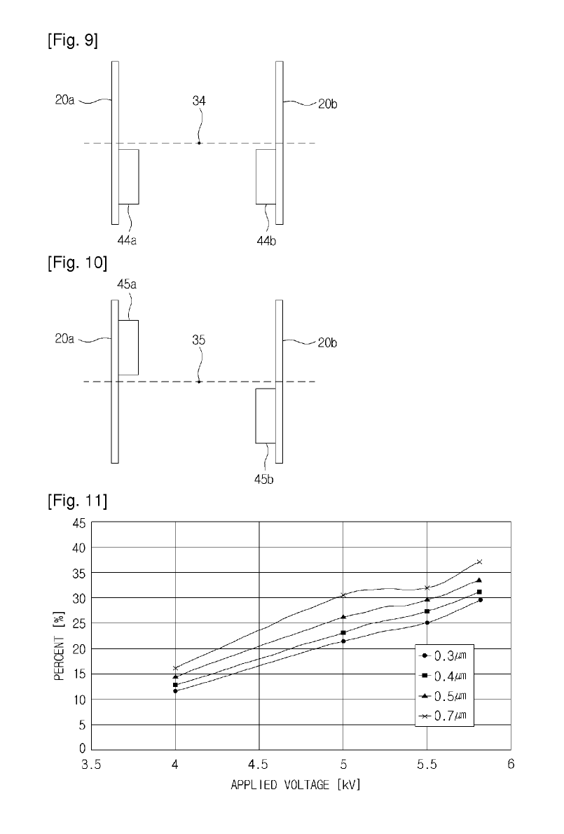

FIGS. 7 and 10 are views illustrating an air purifier according to other embodiments.

Referring to FIG. 7, magnetic force generators 42a and 42b according to still another embodiment are mounted higher than a position (height) where a discharge electrode 32 has been formed (referred to as a ‘front alignment’ hereinafter).

Referring to FIG. 8, the centers of magnetic force generators 43a and 43b according to still another embodiment are mounted at a position (height) equal to a position (height) where a discharge electrode 33 has been formed (referred to as a ‘center alignment’ hereinafter).

Referring to FIG. 9, magnetic force generators 44a and 44b according to still another embodiment are mounted lower than a position (height) where a discharge electrode 34 has been formed (referred to as a ‘rear alignment’ hereinafter).

Referring to FIG. 10, magnetic force generators 45a and 45b according to still another embodiment are mounted such that the first magnetic force generator 45a is mounted in the form of the front alignment, and the second magnetic force generator 45b is mounted in the form of the rear alignment (referred to as a ‘zigzag alignment’ hereinafter).

That is, according to the zigzag alignment, the magnetic force generators 45a and 45b are mounted at different heights, respectively, when they are mounted on flat plates 20a and 20b, respectively, to allow attractive force to be applied to a wider space even when the widths of the magnetic force generators 45a and 45b are narrow.

FIG. 11 is a graph illustrating dust collecting efficiency of the air purifier according to the embodiment.

The air conditioner according to the embodiment includes the discharge electrode 30 made of a tungsten wire having a diameter of 0.1 mm, and the ground electrode part 20 made of stainless flat plates of 400 mm×18 mm. An interval between the discharge electrode 30 and the flat plates of the ground electrode part 20 is 8.5 mm. Four flat plates are used. A ferrite magnet having residual magnetic flux density of 3,900 Gauss and resistance of 10,000 ohm is used as the magnetic force generator 40. The width of the magnetic force generator 40 is 10 mm.

Experiment conditions are a flow velocity of 0.75 m/s, flux of 1,500 l/min, DC power, and atmospheric pressure at room temperature.

FIG. 11 illustrates dust collecting efficiency of the air purifier according to the intensity of a voltage and the size of fine particles.

Referring to FIG. 11, dust collecting efficiency is 22-35% at an application voltage of 5 kV.

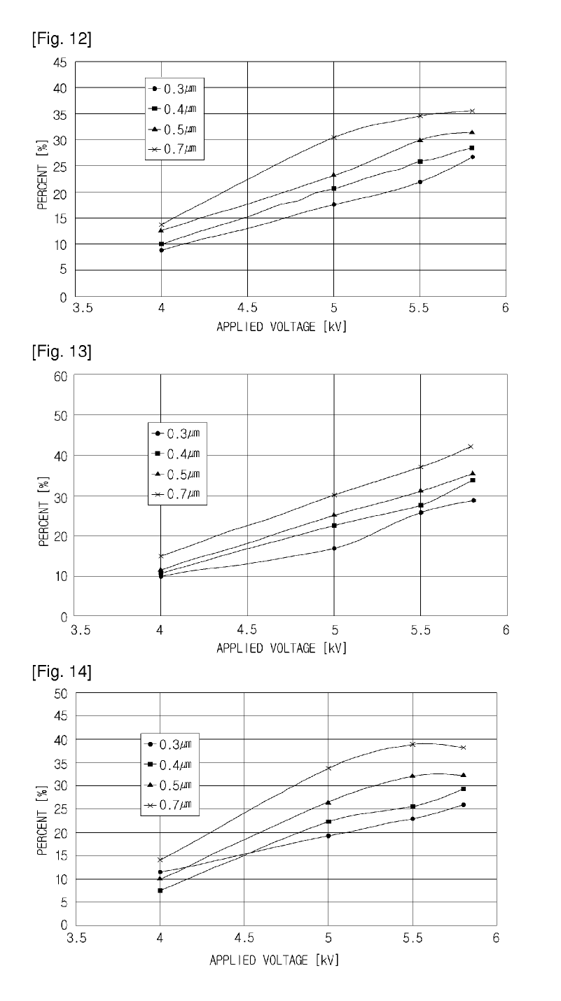

FIGS. 12 to 15 are graphs illustrating dust collecting efficiency of the air purifier according to other embodiments. In this case, the width or height of a magnetic force generator is 3 mm.

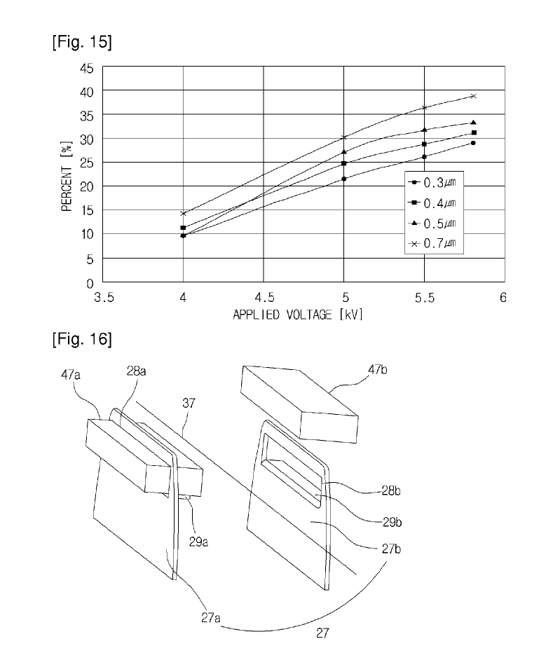

Referring to FIGS. 12 and 15, when an application voltage is 5 kV and the size of a fine dust particle is 0.7 μm, dust collecting efficiency is 30% or more.

FIG. 16 is a view illustrating the construction of an air purifier according to still another embodiment.

Referring to FIG. 16, the air purifier includes a ground electrode part 27, a discharge electrode 37, and magnetic force generators 47a and 47b. The ground electrode part 27 that is a cathode has flat plates 27a and 27b that are parallel to and separated from each other by a predetermined distance. The discharge electrode 37 that is an anode is separated by a predetermined distance between the flat plates 27a and 27b of the ground electrode part 27 to generate an electric field in a space between the flat plates 27a and 27b. The magnetic force generators 47a and 47b are mounted on the flat plates 27a and 27b of the ground electrode part 27, respectively, to generate a magnetic field in the space where the electric field has been generated.

In detail, the flat plates 27a and 27b include mounting units allowing the magnetic force generators 47a and 47b to be mounted, respectively.

The mounting unit includes a receiving hole 28a (28b) receiving the magnetic force generator 47a (47b), and a support 29a (29b) supporting the magnetic force generator 47a (47b).

While received in the receiving holes 28a and 28b, the magnetic force generators 47a and 47b protrude to both sides of the flat plates 27a and 27b, respectively, to generate the magnetic field in both directions of the flat plates 27a and 27b.

Also, the support 29a and 29b can support the lower surfaces of the magnetic force generators 47a and 47b, or can be formed to fixedly support the lateral sides of the magnetic force generators 47a and 47b. Alternatively, the supports 29a and 29b can be coupled to the magnetic force generators 47a and 47b using an insulating material such as a separate adhesive.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An air purifier comprising:
a ground electrode part having at least a pair of flat plates;
a discharge electrode between the flat plates, separated from the flat plates;
at least a pair of magnetic force generators provided to flat plates, respectively, to generate a magnetic field and allow attractive force to be applied between the flat plates; and
a voltage generator applying a voltage between the ground electrode part and the discharge electrode.

2. The air purifier according to claim 1, wherein the discharge electrode comprises a line electrode.

3. The air purifier according to claim 1, wherein the discharge electrode comprises an anode, and the ground electrode part comprises a cathode.

4. The air purifier according to claim 1, wherein the magnetic force generator is mounted on a surface of each flat plate toward the discharge electrode.

5. The air purifier according to claim 4, wherein the magnetic force generators comprise a first magnetic force generator and a second magnetic force generator, and one of an N pole and an S pole of the first magnetic force generator faces one of an S pole and an N pole of the second magnetic force generator.

6. The air purifier according to claim 4, wherein each magnetic force generator is mounted on the each flat plate at a position higher than that of the discharge electrode.

7. The air purifier according to claim 4, wherein each magnetic force generator is mounted on the each flat plate at a position lower than that of the discharge electrode.

8. The air purifier according to claim 4, wherein each magnetic force generator is mounted on the each flat plate such that a center of the each magnetic force generator is equal to a position of the discharge electrode.

9. The air purifier according to claim 4, wherein the magnetic force generators are mounted on the flat plates at different heights, respectively.

10. The air purifier according to claim 1, wherein each flat plate comprises a mounting unit allowing each magnetic force generator to be mounted.

11. The air purifier according to claim 10, wherein the mounting unit comprises a receiving hole passing through the each flat plate to receive the each magnetic force generator.

12. The air purifier according to claim 11, wherein the mounting unit further comprises a support supporting the each magnetic force generator with the each magnetic force generator received in the receiving hole.

13. An air conditioner comprising:
a main body in which an air intake hole and an air discharge hole are formed;
a heat exchanger provided to the main body to allow air suctioned through the air intake hole to exchange heat; and
an air purifier purifying air suctioned to the main body, the air purifier comprising:
a ground electrode part having a pair of flat plates, the ground electrode being an anode;
a discharge electrode between the flat plates, the discharge electrode being a cathode;
at least a pair of magnetic force generators provided to flat plates, respectively, to generate a magnetic field and allow attractive force to be applied between the flat plates; and
a voltage generator applying a voltage between the ground electrode part and the discharge electrode.

14. The air conditioner according to claim 13, further comprising a mounting case fixing the air purifier to the heat exchanger.

15. The air conditioner according to claim 13, wherein the magnetic force generators comprise a first magnetic force generator and a second magnetic force generator, and one of an N pole and an S pole of the first magnetic force generator faces one of an S pole and an N pole of the second magnetic force generator.
